(19) United States
(12) Patent Application Publication
(10) Pub. No.: US 2023/0382563 A1
(43) Pub. Date: Nov. 30, 2023

(54) Systems and Methods for Solar Communication and Defense Networks

(71) Applicant: Yiming Huo, Victoria (CA)

(72) Inventor: Yiming Huo, Victoria (CA)

(21) Appl. No.: 18/144,200

(22) Filed: May 7, 2023

Related U.S. Application Data
(60) Provisional application No. 63/339,848, filed on May 9, 2022.

(51) Int. Cl. B64G 1/10; B64G 1/68; B64G 1/24

(52) U.S. Cl. CPC B64G 1/1007; B64G 1/68; B64G 1/2422

(57) ABSTRACT

Generally, this disclosure provides systems and methods for solar communication and defense networks. A system may comprise
a sun and a plurality of celestial bodies;
a plurality of mutual orbits of the sun and celestial bodies;
and
a plurality of spacecraft each of which comprises at least a transmitter, a receiver, an antenna, a sensing device that is capable of monitoring and detecting space objects, a system that is able to adjust the orbit, and a system that is able to intercept space objects.

### CROSS-REFERENCE TO RELATED APPLICATIONS

The present Utility patent application claims priority benefit of the U.S. provisional application for patent Ser. No. 63/339,848, titled “Systems and Methods for Solar Communication and Defense Networks”, filed on May 9, 2022, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Provisional application No. 63/339,848, filed on May 9, 2022.

### FIELD OF THE INVENTION

One or more embodiments of the invention generally relate to wireless communications, sensing, and defense. More particularly, the invention relates to wireless communications, sensing, and detection within the solar system, planetary defense, multi-planetary defense, extra-terrestrial defense, and outer-space defense.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present disclosure, or any embodiments thereof, to anything stated or implied therein or inferred thereupon.

Extra-Terrestrialization is defined as making life multi-planetary. It is believed to be the unavoidable evolution path for human. It is generally believed that life on Earth began in the water and had been aquatic for billions of years. About 530 million years ago, sea creatures likely related to arthropods first began to make forays onto land. Terrestrial invasion is one important milestone in the history of life, and the evolution of terrestrial vertebrates started around 385 million years ago. Today, on one hand, mankind's sensory abilities in both microscopic and macroscopic scales have been constantly enhanced by the technological advancements, and on the other hand potential resources in outer space and other celestial bodies have driven humans to evolve into a spacefaring civilization, which can also increase the probability of mankind's survival and prosperity in the universe. We can define this transformation as ‘Extra-Terrestrialization’ in the history of life.

Founding a human base or even a self-sustaining city on another celestial body is challenging in light of the current technological level. Building the first colonization for humankind on another celestial body without or with a thin atmosphere, with more severe damage from cosmic rays, solar radiation, or even asteroid impact, has a challenging kickoff. Specifically, building necessary infrastructures and constructing reliable shelters either on the ground or underground is a huge mission requiring significant workforces and resources that depend on transportation at the very beginning. Take Mars, for example, 1 million people is a threshold required to maintain a civilization, which translates to at least 10,000 trips and order of 1,000 ships. Another challenge is, the Earth-Mars rendezvous timing is roughly 26 months when the distance between two celestial bodies becomes periodically minimum, which means a huge number of preparation and launch will occur in a very narrow time window and the Mars fleet have to depart en masse.

Hazards such as asteroids and comets originating beyond Earth have the potential to cause devastating consequences for both our planet and any extraterrestrial settlements on other celestial bodies. The Cretaceous-Paleogene (K-Pg) extinction event is also known as the Cretaceous-Tertiary (K-T) extinction and it was a sudden mass extinction of around 75% of the plant and animal species on Earth, which happened approximately 66 million years ago. The root cause of the K-Pg extinction event was originally proposed to be the impact of a massive comet or asteroid 10 to 15 km wide about 66 million years ago, by a team of scientists led by Nobel Prize-winning physicist Luis Alvarez and his son Walter. The impact hypothesis is also known as the Alvarez hypothesis and got supported by the discovery of the 180 km sized Chicxulub crater in the Gulf of Mexico's Yucatan Peninsula.

One of the possible and feasible strategies is to deploy more survey stations dedicated to discovering more asteroids/comets, which are not only categorized as NEOs (near-Earth objects) but also are located in more distant regions. However, finding ideal locations for ground observatories is challenging since many unique conditions are expected to be fulfilled. Moreover, when looking at the bigger picture, the ground observatories in the Northern Hemisphere or the Southern Hemisphere can only observe some portion of the entire sky. Joint efforts should be synchronized to thoroughly survey the entire sky in order not to miss any suspicious near-Earth object.

On the other hand, on-ground telescopes for the NEO survey mainly use radio frequencies and visible light. Only a few of them are infrared-based, which hold some advantages, one of which is, for example, when observing in the near-infrared, the dust is transparent to it. Another advantage is that relatively cold objects invisible to optical telescopes become visible in the infrared. Consequently, an infrared-facilitated survey is beneficiary for detecting asteroids/comets, which are usually cold and hard to be discovered. So far, multiple infrared-based space telescopes have been in service.

As the costs of space launches and spacecraft construction continue to decline, the possibility and feasibility of creating an extensive deep space network throughout the solar system emerges. Establishing such a network is vital for fostering the progress and well-being of future human civilization.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 illustrates a detailed perspective of orbital planning between the Sun and another planet, highlighting the five Lagrange points.

FIG. 2 illustrates an exemplary perspective of an orbital plan for the Solar Communications and Defense Network (SCADN) framework where spacecraft are located on four Lagrange points of each orbit.

FIG. 3 illustrates exemplary communication links based on the SCADN framework.

FIG. 4 is a flow chart illustrating an exemplary process for wireless communications based on the framework, in accordance with an embodiment.

FIG. 5 illustrates a top-level system diagram of detecting, intercepting and mitigating space objects, in accordance with an embodiment.

FIG. 6 is a flow chart illustrating an exemplary process of detecting, intercepting and mitigating space objects, in accordance with an embodiment.

FIG. 7 illustrates an exemplary top-level system diagram of spacecraft/satellites deployment based on the SCADN framework.

### DETAILED DESCRIPTION

Some embodiments of the present disclosure and variations thereof, relate to wireless communications systems. Some of these embodiments may comprise computer software. In some of these embodiments, software may be integrated into hardware, including, without limitation, uniquely designed hardware for running embodiment software.

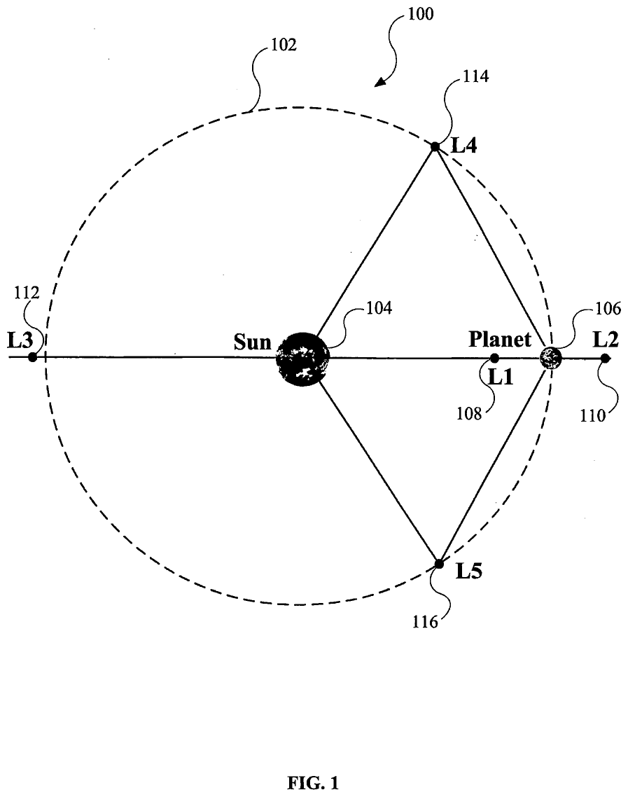

FIG. 1 illustrates a detailed perspective of orbital planning between the Sun and another planet, highlighting the five Lagrange points. An orbital planning 100 comprises of the Sun 104, a planet 106, the mutual orbit of the Sun 104 and the planet 102, the L₁ Lagrange point 108, the L₂ Lagrange point 110, the L₃ Lagrange point 112, the L₄ Lagrange point 114, the L₅ Lagrange point 116. In celestial mechanics, these Lagrange points are points of equilibrium for small-mass objects under the influence of two massive orbiting bodies. At the Lagrange points, the gravitational forces of the two large bodies and the centrifugal force balance each other. This can make Lagrange points an excellent location for spacecraft, as few orbit corrections are needed to maintain the desired orbit. Small objects placed in orbit at Lagrange points are in equilibrium in at least two directions relative to the center of mass of the large bodies.

During a typical orbital deployment operation, one or more spacecraft will be sent to each of the five Lagrange points, namely 108, 110, 112, 114, and 116. The spacecraft can be launched directly from Earth or any other celestial body.

It may be appreciated by a person with ordinary skill in the art that a planet 106 can be any planet in a solar system. There can be one or multiple artificial objects such as spacecraft or satellites, deployed into the five Lagrange points.

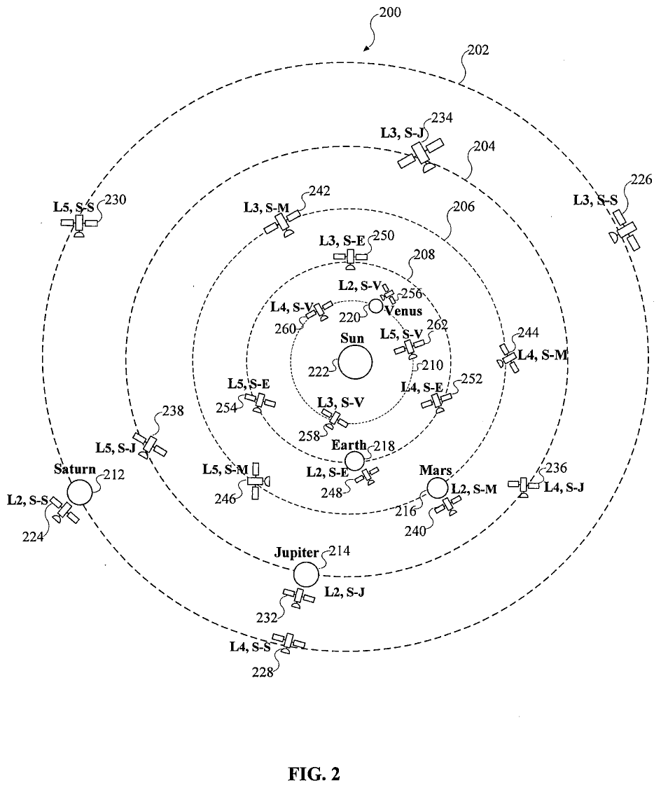

FIG. 2 illustrates an exemplary perspective of an orbital plan for the Solar Communications and Defense Network (SCADN) framework where spacecraft are located on four Lagrange points of each orbit. An orbital planning 200 comprises celestial bodies such as the Sun 222, Venus 220, Earth 218, Mars 216, Jupiter 214, and Saturn 212, and the mutual orbit of the Sun and Venus 220, the mutual orbit of the Sun 222 and Earth 218, the mutual orbit of the Sun 222 and Mars 216, the mutual orbit of the Sun 222 and Jupiter 214, and the mutual orbit of Sun and Saturn 212. The mutual orbit of the Sun 222 and Venus 220 comprises spacecraft 256, 258, 260, and 262 on the Lagrange points L_{2, S-V}, L_{3, S-V}, L_{4, S-V}, and L_{5, S-V}, respectively. The mutual orbit of the Sun 222 and Earth 218 comprises spacecraft 248, 250, 252, and 254 on the Lagrange points L_{2, S-E}, L_{3, S-E}, L_{4, S-E}, and L_{5, S-E}, respectively. The mutual orbit of the Sun 222 and Mars 216 comprises spacecraft 240, 242, 244, and 246 on the Lagrange points L_{2, S-M}, L_{3, S-M}, L_{4, S-M}, and L_{5, S-M}, respectively. The mutual orbit of the Sun 222 and Jupiter 214 comprises spacecraft 232, 234, 236, and 238 on the Lagrange points L_{2, S-J}, L_{3, S-J}, L_{4, S-J}, and L_{5, S-J}, respectively. The mutual orbit of the Sun 222 and Saturn 212 comprises spacecraft 224, 226, 228, and 230 on the Lagrange points L_{2, S-S}, L_{3, S-S}, L_{4, S-S}, and L_{5, S-S}, respectively.

It may be appreciated by a person with ordinary skill in the art that one or several artificial entities, such as spacecraft or satellites, can be positioned at each of the four Lagrange points in the mutual orbits of the Sun 222 and a planet.

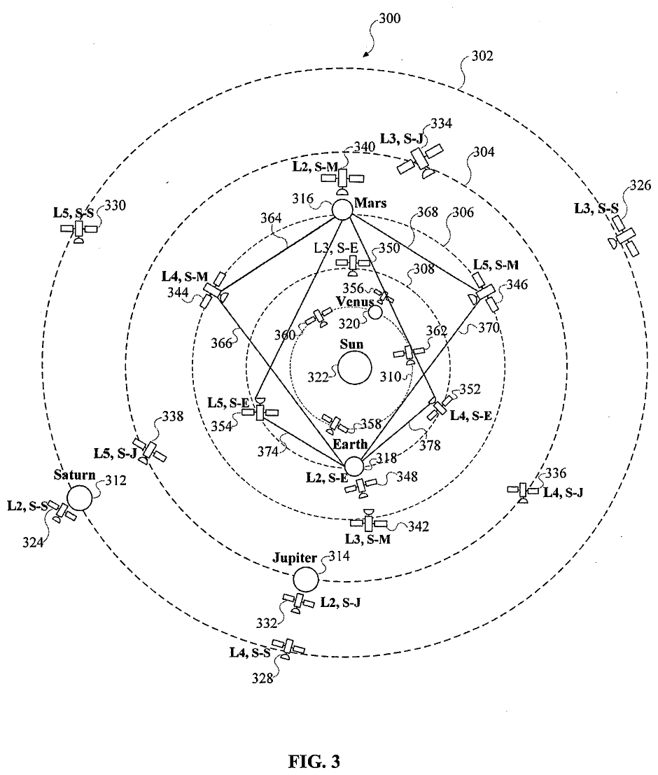

FIG. 3 illustrates exemplary communication links based on the SCADN (Solar Communications and Defense Network) framework. The SCADN framework 300 comprises celestial bodies such as the Sun 322, Venus 320, Earth 318, Mars 316, Jupiter 314, and Saturn 312, and the mutual orbit of the Sun and Venus 320, the mutual orbit of the Sun 322 and Earth 318, the mutual orbit of the Sun 322 and Mars 316, the mutual orbit of the Sun 322 and Jupiter 314, and the mutual orbit of the Sun 322 and Saturn 312. The mutual orbit of the Sun 322 and Venus 320 comprises spacecraft 356, 358, 360, and 362 on the Lagrange points L_{2, S-V}, L_{3, S-V}, L_{4, S-V}, and L_{5, S-V}, respectively. The mutual orbit of the Sun 322 and Earth 318 comprises spacecraft 348, 350, 352, and 354 on the Lagrange points L_{2, S-E}, L_{3, S-E}, L_{4, S-E}, and L_{5, S-E}, respectively. The mutual orbit of the Sun 322 and Mars 316 comprises spacecraft 340, 342, 344, and 346 on the Lagrange points L_{2, S-M}, L_{3, S-M}, L_{4, S-M}, and L_{5, S-M}, respectively. The mutual orbit of the Sun 322 and Jupiter 314 comprises spacecraft 332, 334, 336, and 338 on the Lagrange points L_{2, S-J}, L_{3, S-J}, L_{4, S-J}, and L_{5, S-J}, respectively. The mutual orbit of the Sun 322 and Saturn 312 comprises spacecraft 324, 326, 328, and 330 on the Lagrange points L_{2, S-S}, L_{3, S-S}, L_{4, S-S}, and L_{4, S-S}, respectively.

During a typical communication operation, all spacecraft can communicate with each other in a wireless way including radio and optical frequencies. All spacecraft can communicate directly with any planet's communication infrastructure when the communication quality is satisfied.

During a typical communication relay operation, when Solar conjunction for Mars 316 and Earth 318 (Mars and Earth are aligned on the opposite sides of the Sun) happens, spacecraft 344 and 346 on the Lagrange points L_{4, S-M}, and L_{5, S-M} relay the wireless signals from Mars 316 to Earth 318 or from Earth 318 to Mars 316.

During another typical communication relay operation, when Solar conjunction for Mars 316 and Earth 318 (Mars and Earth are aligned on the opposite sides of the Sun) happens, spacecraft 352 and 354 on the Lagrange points L_{4, S-E}, and L_{5, S-E} relay the wireless signals from Mars 316 to Earth 318 or from Earth 318 to Mars 316.

During a typical sky survey operation, any spacecraft within the SCADN framework 300, potential hazards to Earth, human lives, and property on other celestial bodies or in space can be identified and monitored, ensuring overall safety.

It may be appreciated by a person with ordinary skill in the art that any radio and optical frequencies can be utilized by any spacecraft within the SCADN framework 300 to fulfill communication and survey purposes.

It may be appreciated by a person with ordinary skill in the art that these established links within the SCADN framework 300 can be utilized to transmit information and energy simultaneously, synchronously, or asynchronously.

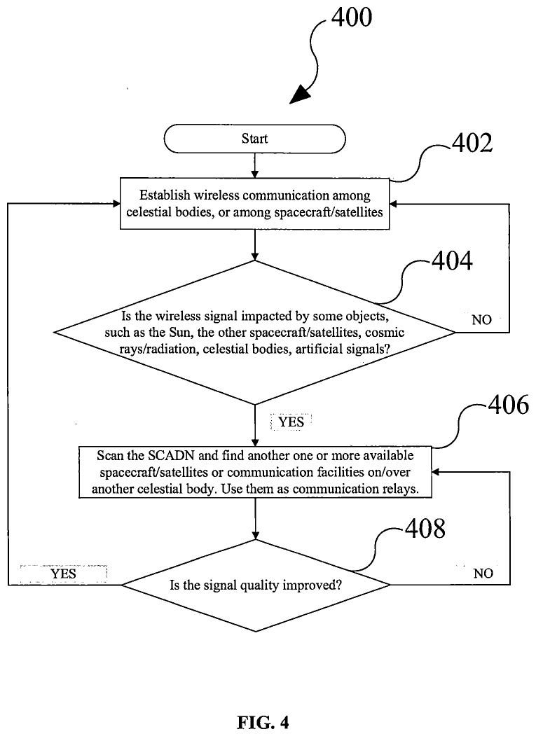

FIG. 4 is a flow chart illustrating an exemplary process for wireless communications based on the SCADN framework, in accordance with an embodiment. The wireless communications based on the SCADN framework process 400 comprises a wireless communications establishment step 402, a conditional decision about the signal quality step 404, a SCADN operation step 406, and a conditional decision about signal quality improvement step 408.

Referring now to FIG. 2, and FIG. 3, the wireless communications based on the SCADN framework process 400 begins with the establishment of wireless communications step 402 that exists among multiple celestial bodies or spacecraft/satellites within the solar system 200/300. A conditional decision about the signal quality 404 may be conducted by any spacecraft within 200/300, or the infrastructure on any planet/celestial body within the solar system 200/300.

If the wireless signal is impacted by some objects or events, including but not limited to the Sun, solar flare, coronal mass ejection, cosmic rays/radiation, celestial bodies, and other artificial interferences, the SCADN operation step 406 should be initialized to scan and examine the entire SCADN network to find another one or multiple spacecraft/satellites, or communication facilities on/over another one or more celestial bodies. Subsequently, the available spacecraft/satellites or communication facilities will function as communication relays.

If performing the SCADN operation step 406 can lead to better and satisfying signal quality in the step of conditional decision about signal quality improvement 408, the wireless communications based on the SCADN framework process 400 will re-enter step 402, otherwise, it will re-enter step 406 until better and satisfying signal quality is obtained.

It may be appreciated by a person with ordinary skill in the art that the Sun can introduce very severe interference to the radio and optical signals over a very large spectrum, particularly when the signal propagation path is very close to the Sun.

It may be appreciated by a person with ordinary skill in the art that every step of the wireless communications based on the SCADN framework process 400 may involve a series of protocols and artificial intelligence (AI) aided management.

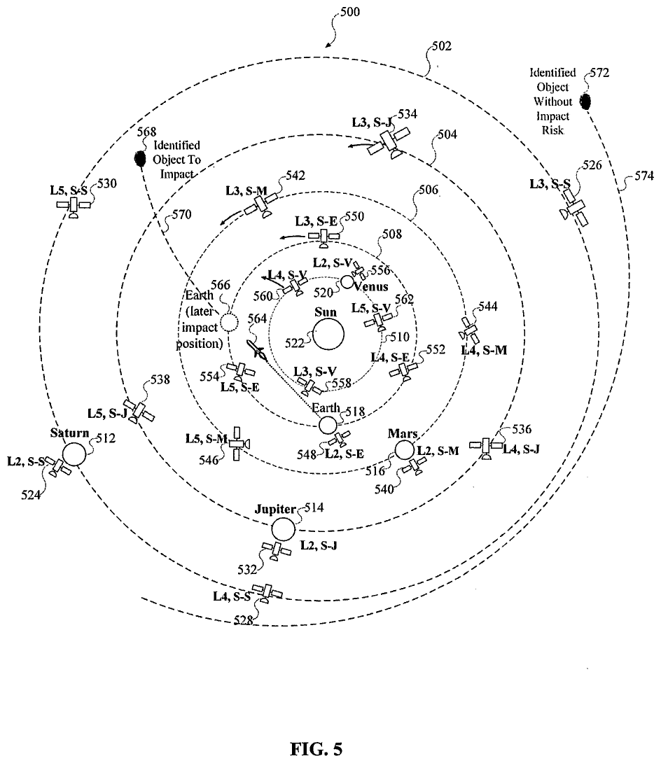

FIG. 5 illustrates a top-level system diagram of detecting, intercepting and mitigating space objects, in accordance with an embodiment. The system diagram of the SCADN network capable of detecting, intercepting, and mitigating space objects 500 comprises celestial bodies such as the Sun 522, Venus 520, Earth 518, Mars 516, Jupiter 514, and Saturn 512, and the mutual orbit of the Sun and Venus 520, the mutual orbit of the Sun 522 and Earth 518, the mutual orbit of the Sun 522 and Mars 516, the mutual orbit of the Sun 522 and Jupiter 514, the mutual orbit of the Sun 522 and Saturn 512, the artificial object launched from Earth to intercept 564, the identified object to impact 568, the later impact position of Earth 566, the trajectory of the identified object to impact 570, the identified object without impact risk 572, the trajectory of the identified object without impact risk 574. The mutual orbit of the Sun 522 and Venus 520 comprises spacecraft 556, 558, 560, and 562 on the Lagrange points L_{2, S-V}, L_{3, S-V}, L_{4, S-V}, and L_{5, S-V}, respectively. The mutual orbit of the Sun 522 and Earth 518 comprises spacecraft 548, 550, 552, and 554 on the Lagrange points L_{2, S-E}, L_{3, S-E}, L_{4, S-E}, and L_{5, S-E}, respectively. The mutual orbit of the Sun 522 and Mars 516 comprises spacecraft 540, 542, 544, and 546 on the Lagrange points L_{2, S-M}, L_{3, S-M}, L_{4, S-M}, and L_{5, S-M}, respectively. The mutual orbit of the Sun 522 and Jupiter 514 comprises spacecraft 532, 534, 536, and 538 on the Lagrange points L_{2, S-J}, L_{3, S-J}, L_{4, S-J}, and L_{5, S-J}, respectively. The mutual orbit of the Sun 522 and Saturn 512 comprises spacecraft 524, 526, 528, and 530 on the Lagrange points L_{2, S-S}, L_{3, S-S}, L_{4, S-S}, and L_{4, S-S}, respectively.

During a typical operation of the SCADN network detecting, intercepting, and mitigating space objects, the SCADN network surveys the sky, detects the potential object to impact Earth 568, and calculates the trajectory of the identified object to impact 570. Furthermore, the SCADN network sends spacecraft/satellites and artificial objects to intercept the identified object to impact 568. In the exemplary situation, spacecraft 542, 550, and 560 on orbits L_{3, S-M}, L_{3, S-E}, and L_{4, S-V}, and the object 564 will be mobilized to intercept the identified object to impact 568.

It may be appreciated by a person with ordinary skill in the art that any spacecraft/satellites within the SCADN network can be commanded to intercept the identified space object. One or multiple times of interceptions by one or multiple spacecraft might be required to completely mitigate the threat of space objects.

It may be appreciated by a person with ordinary skill in the art that the overall strategy of detection and interception can be performed both manually and by AI.

It may be appreciated by a person with ordinary skill in the art that the spacecraft/satellites can be equipped with devices and methods that can facilitate the interception, including but not limited to explosive devices, kinetic impact devices, laser ablation, ion beam shepherd, focused solar energy.

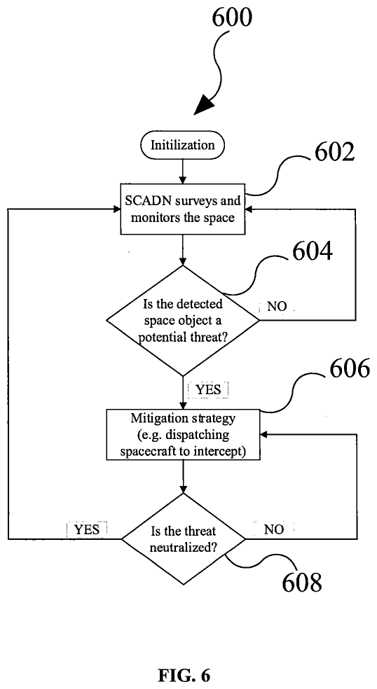

FIG. 6 is a flow chart illustrating an exemplary process of detecting, intercepting and mitigating space objects, in accordance with an embodiment. The process of detecting, intercepting and mitigating space objects based on the SCADN framework 600 comprises a step of surveying and monitoring the space 602, a step of the conditional decision about whether the space object is a threat 604, a step of performing mitigation strategy 606, and a conditional decision about whether the threat is neutralized 608.

Referring now to FIG. 5, the system diagram of the SCADN network capable of detecting, intercepting, and mitigating space objects 500 begins with the initialization of SCADN surveying and monitoring the space and sky. If a space object is detected by any spacecraft/satellites and then is determined to pose a potential threat in the step 604, the mitigation strategy in the step 606 will be initialized. One or multiple spacecraft/satellites will be re-deployed to intercept the space object. The SCADN network will re-enter the step 606 to perform more intercepting efforts until the threat is confirmed to be neutralized in the step 608.

It may be appreciated by a person with ordinary skill in the art that the spacecraft/satellites can be equipped with devices and methods that can facilitate the interception, including but not limited to explosive devices, kinetic impact devices, laser ablation, ion beam shepherd, focused solar energy. Using which type(s) of mitigation technology depends on the actual application scenario and many factors including but not limited to, the dimension, mass, and threat level of the space object.

It may be appreciated by a person with ordinary skill in the art that the process of detecting, intercepting and mitigating space objects based on the SCADN framework 600 may involve a series of protocols and artificial intelligence (AI) aided management.

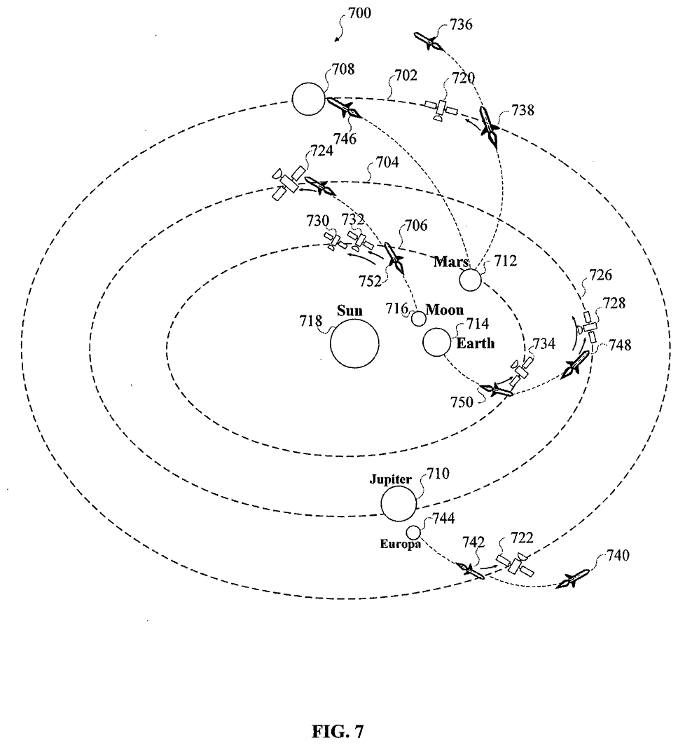

FIG. 7 illustrates an exemplary top-level system diagram of spacecraft/satellites deployment based on the SCADN framework. The system diagram of spacecraft/satellites deployment based on the SCADN framework 700 comprises celestial bodies such as the Sun 718, Earth 714, Moon 716, Mars 712, Jupiter 710, and Saturn 708, Europa 744, the mutual orbit of the Sun and Mars 706, the mutual orbit of the Sun and Jupiter 704, the mutual orbit of the Sun and Saturn 702, the launching vehicles 736, 738, 740, 742, 744, 746, 748, 750, 752, the spacecraft/satellites 720, 722, 724, 726, 728, 730, 732.

During a typical operation of spacecraft/satellites deployment based on the SCADN framework, one or multiple launching vehicles such as 736, 738, 740, 742, 744, 746, 748, 750, 752, will carry one or multiple spacecraft/satellites such as 720, 722, 724, 726, 728, 730, 732, into the orbits such as 702, 704, and 706.

It may be appreciated by a person with ordinary skill in the art that launching vehicles can be launched from any possible celestial body including but not limited to, Moon 716, Europa 744.

It may be appreciated by a person with ordinary skill in the art that spacecraft/satellites such as 720, 722, 724, 726, 728, 730, 732, may require further orbital adjustment so that they can be positioned in the expected positions such as Lagrange points.

It may be appreciated by a person with ordinary skill in the art that launching vehicles can help deploy one or multiple spacecraft/satellites into further orbits other than the mutual orbit of the Sun and Saturn.

It may be appreciated by a person with ordinary skill in the art that the process of spacecraft/satellites deployment based on the SCADN framework may involve a series of protocols and artificial intelligence (AI) aided management.

What is claimed is:

1. A system for solar communication and defense networks, or comprising:
a sun and a plurality of celestial bodies;
a plurality of mutual orbits of the sun and celestial bodies; and
a plurality of spacecraft each of which comprises at least a transmitter, receiver, an antenna, a sensing device that is capable of monitoring and detecting space objects, a system that is able to adjust the orbit, and a system that is able to intercept space objects.

2. The system of claim 1, wherein each of the said mutual orbits of the sun and celestial bodies comprises five Lagrange points where the gravitational forces of the two large bodies and the centrifugal force balance each other.

3. The system of claim 1, wherein said spacecraft are deployed to Lagrange points of each mutual orbit of the sun and celestial bodies.

4. The system of claim 1, wherein said transmitter and receiver of a spacecraft comprise circuits and protocols to transmit and receive radio or optical signals, spanning a wide range of frequencies from MHz, GHz to millimeter wave (mmWave), Terahertz, infrared or optical frequencies.

5. The system of claim 1, wherein said antenna includes an antenna and antenna system, and is configured to form beams pointing to designated directions with particular beamwidths and gains that are amenable to transmission or reception.

6. The system of claim 1, wherein said sensing device of a spacecraft comprise circuits and protocols to monitor and detect the space object, spanning a wide range of frequencies from MHz, GHz to millimeter wave (mmWave), Terahertz (THz), infrared, optical frequencies, ultraviolet frequencies, X-rays, Gamma-rays.

7. The system of claim 1, wherein said system that is able to adjust the orbit comprises hardware, and protocols to adjust the position, gesture, mobility, and velocity of spacecraft.

8. The system of claim 1, wherein said system that is able to intercept space objects comprises hardware, and protocols to adjust the spacecraft and commands the spacecraft to perform intercepting strategies.

9. A method of communications and defense across the solar system using broad networks deployed in the solar system, the method comprising:
deploying spacecraft into Lagrange points of each mutual orbit of the Sun and a celestial body;
performing communications among spacecraft, between spacecraft, and any artificial infrastructure on any celestial body;
performing monitoring of the space and detection of the space object which can pose a threat to the safety of humanity and property;
performing interception and mitigation of the space object which can pose a threat to the safety of humanity and property.
